(19) United States
(12) Patent Application Publication
(10) Pub. No.: US 2024/0420043 A1
(43) Pub. Date: Dec. 19, 2024

(54) INFORMATION PROCESSING APPARATUS AND INFORMATION PROCESSING METHOD

(71) Applicant: Panasonic Intellectual Property Corporation of America, Torrance, CA (US)

(72) Inventors: Taro SUZUKI, Ibaraki (JP); Kazunobu KONISHI, Osaka (JP); Hiroko IZUMI, Kanagawa (JP); Mitsuko SHUTO, Osaka (JP)

(73) Assignee: Panasonic Intellectual Property Corporation of America, Torrance, CA (US)

(21) Appl. No.: 18/822,372

(22) Filed: Sep. 2, 2024

Related U.S. Application Data
(63) Continuation of application No. PCT/JP2022/034464, filed on Sep. 14, 2022.

(30) Foreign Application Priority Data
Mar. 28, 2022 (JP) 2022-051915

(51) Int. Cl. G06Q 10/0631

(52) U.S. Cl. CPC G06Q 10/063114

(57) ABSTRACT

An event management system includes a device and an event management apparatus. The event management apparatus creates a task that should be accomplished in relation to a use of the device connected to a network. The event management apparatus acquires data related to a user's use of the device. The event management apparatus evaluates a level of task accomplishment of the user using the device. The event management apparatus communicates with the device and sets the function of the device according to the level of task accomplishment.

### BACKGROUND

### 1. Field

The present disclosure relates to a data processing technology and, in particular, to an information processing apparatus and an information processing method.

### 2. Description of the Related Art

Electrical devices and facility devices connected to a network and communicable with an external device (hereinafter also referred to as “IoT device”. IoT stands for “Internet of Things”) have been come to be used widely in homes and facilities. In Patent Literature 1 listed below, a technology for promoting the use of IoT devices by users is proposed.

### [Patent Literature 1] JP2021-128544

Patent Literature 1 describes that a user is defined as an exemplar user based on a record of the user using an IoT device and is provided with a bonus such as a coupon. We consider that there is room for improvement to promote the use of IoT devices by users effectively.

### SUMMARY

The present disclosure addresses the above recognition, and a purpose thereof is to provide a technology to promote the use of a IoT device effectively.

An information processing apparatus according to an embodiment of the present disclosure includes: a task creation unit that creates a task that should be accomplished in relation to a use of a device connected to a network; a usage data acquisition unit that acquires data related to a user's use of the device; an evaluation unit that evaluates a level of task accomplishment of the user using the device; and a setting unit that communicates with the device to set a function of the device according to the level of task accomplishment.

Another embodiment of the present disclosure relates to an information processing method. The method includes computer-implemented steps of: creating a task that should be accomplished in relation to a use of a device connected to a network; acquiring data related to a user's use of the device; evaluating a level of task accomplishment of the user using the device; and communicating with the device to set a function of the device according to the level of task accomplishment.

Optional combinations of the aforementioned constituting elements, and implementations of the present disclosure in the form of systems, computer programs, and recording mediums recording computer programs may also be practiced as additional modes of the present disclosure.

### BRIEF DESCRIPTION OF THE DRAWINGS

FIG. 1 shows a configuration of an event management system of the exemplary embodiment.

FIG. 2 is a block diagram showing functional blocks of the event management apparatus of FIG. 1.

FIG. 3 shows an example of the user table.

FIG. 4 shows an example of the device specification table.

FIG. 5 shows an example of a facility table.

FIG. 6 shows an example of the installed device table.

FIG. 7 shows an example of the event table.

FIG. 8 shows an example of the group table.

FIG. 9 shows an example of the device log table.

FIG. 10 is a sequence chart showing an operation of the event management system of the exemplary embodiment.

FIG. 11 is a sequence chart showing an operation of the event management system following the operation of FIG. 10.

FIG. 12 is a flowchart showing an operation of the event management apparatus.

### DETAILED DESCRIPTION OF THE EMBODIMENTS

The invention will now be described by reference to the preferred embodiments. This does not intend to limit the scope of the present invention, but to exemplify the invention.

The apparatus or the entity that executes the method according to the disclosure is provided with a computer. By causing the computer to run a program, the function of the apparatus or the entity that executes the method according to the disclosure is realized. The computer is comprised of a processor that operates in accordance with the program as a main hardware feature. The disclosure is non-limiting as to the type of the processor so long as the function is realized by running the program. The processor is comprised of one or a plurality of electronic circuits including a semiconductor integrated circuit (IC) or a large-scale integration (LSI). The terms IC and LSI may change depending on the level of integration, and the processor may be comprised of a system LSI, a Very Large Scale Integration (VLSI), or an Ultra Large Scale Integration (ULSI). A field programmable gate array (FPGA), which is programmed after an LSI is manufactured, or a reconfigurable logic device, in which connections inside the LSI can be reconfigured or circuit compartments inside the LSI can be set up, can be used for the same purpose. The plurality of electronic circuits may be integrated in one chip or provided in a plurality of chips. The plurality of chips may be aggregated in one device or provided in a plurality of devices. The program may be recorded in a computer-readable non-transitory recording medium such as a read only memory (ROM), an optical disk, and a hard disk drive or recorded in a computer-readable transitory storage medium such as a random access memory (RAM). The program may be stored in a recording medium in advance or supplied to a recording medium or a recording medium via wide area communication network including the Internet.

An outline of an exemplary embodiment will be described. An event management apparatus of the exemplary embodiment sets a task that should be accomplished by a user in relation to the use (or usage) of an IoT device provided in an area around an event venue. The event management apparatus of the exemplary embodiment recruits a person who wishes to perform the task from a plurality of users, and sets a function determined by the attribute of the user who executes the task, based on the task accomplishment level (in other words, the status of usage of the IoT device).

The user is typically a person who participates in an event, and the task can also be said to be a mission that should be accomplished by the user participating in the event. The event of the exemplary embodiment is inclusive of both an event in a broad sese and an event in a narrow sense. An event in a broad sense is an event that is to be linked to task execution, and can be said to be an event that attracts customers for task execution, and can be said to be an event to promote task execution. An event in a broad sense encompasses a variety of indoor and outdoor activities, such as concerts and baseball. On the other hand, an event in a narrow sense means a series of events in which a task linked to an indoor or outdoor activity is set and which is executed to determine the level of task accomplishment according to the number of times the task is executed by the user, and update the function of the IoT device accordingly. An event in a narrow sense encompasses, for example, a competition for a position, in which a task that involves a mission of using the IoT device installed in an area around a concert venue a predetermined number of times is set in association with a concert of an idol group and in which fans of the idol group compete in the number of times of use of the IoT device.

The IoT device is a device connected to a network and communicable with an external apparatus and is exemplified by an IoT toilet seat provided in a toilet in a facility around an event venue. A task related to the IoT toilet seat may be, for example, the use of a washing function. Setting the function of the IoT device according to the attribute of the user who executes the task is, for example, setting the function of the IoT device to suit the preference of the user who executes the task. Specifically, the voice of a member of the idol group supported by the one who executes the task may be set as the guidance voice of the IoT device. This can improve the motivation of the user who attempts to use the IoT device and promote the use of the IoT device effectively.

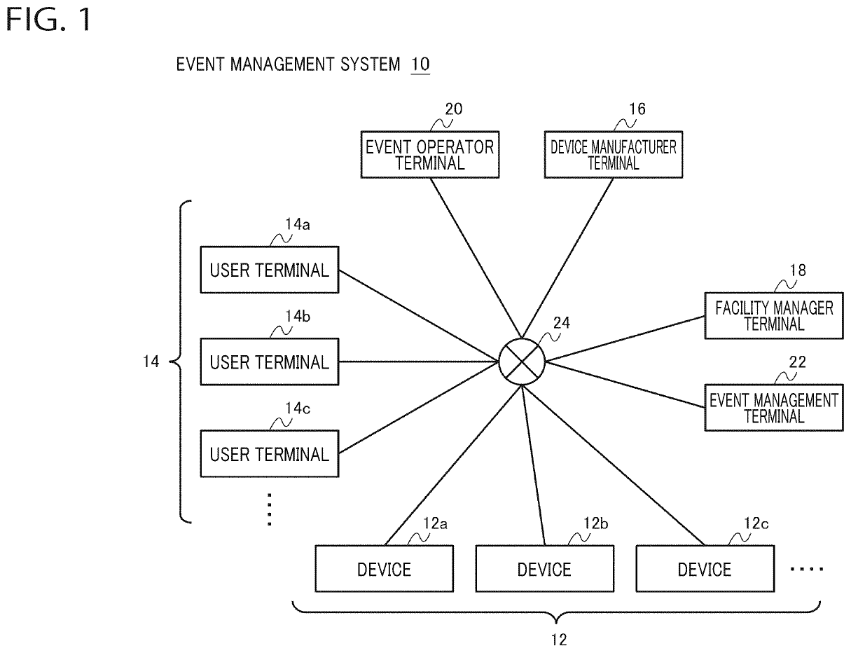

FIG. 1 shows a configuration of an event management system 10 of the exemplary embodiment. The event management system 10 is an information processing system including a plurality of devices 12, a plurality of user terminals 14, a device manufacturer terminal 16, a facility manager terminal 18, an event operator terminal 20, and an event management apparatus 22. The apparatuses constituting the event management system 10 transmit and receive data via a communication network 24 including LAN, WAN, the Internet, and the like.

The plurality of devices 12 are IoT devices installed in the user's residence or various facilities (event venues, shopping centers, etc.). The plurality of devices 12 include a device 12a, a device 12b, and a device 12c having the same specification or different specifications. Hereinafter, the device 12 for which the use of a predetermined function is a condition for accomplishing a task will also be referred to as “the device 12 for which the task is set”.

Each of the plurality of user terminals 14 is an information processing apparatus operated by a user. The plurality of user terminals 14 include, for example, a user terminal 14a, a user terminal 14b, and a user terminal 14c operated by mutually different users. The user is a person who can be a participant to the event and a person who can be a user of the device 12.

The device manufacturer terminal 16 is an information processing apparatus operated by a person in charge at the manufacturing company of the device 12. The facility manager terminal 18 is an information processing apparatus operated by a manager of the facility on which the device 12 is installed. The event operator terminal 20 is an information processing apparatus operated by an eventer or an event operator who plans an event or a service that uses the device 12 at each location. Each of the user terminal 14, the device manufacturer terminal 16, the facility manager terminal 18, and the event operator terminal 20 may be a computer, a smartphone, or a tablet terminal. An eventer is inclusive of a person who is involved in product planning of a company, etc.

The event management system 10 of FIG. 1 is described as including one each of the device manufacturer terminal 16, the facility manager terminal 18, and the event operator terminal 20. In one variation, the event management system 10 may include a plurality of device manufacturer terminals 16, a plurality of facility manager terminals 18, or a plurality of event operator terminals 20.

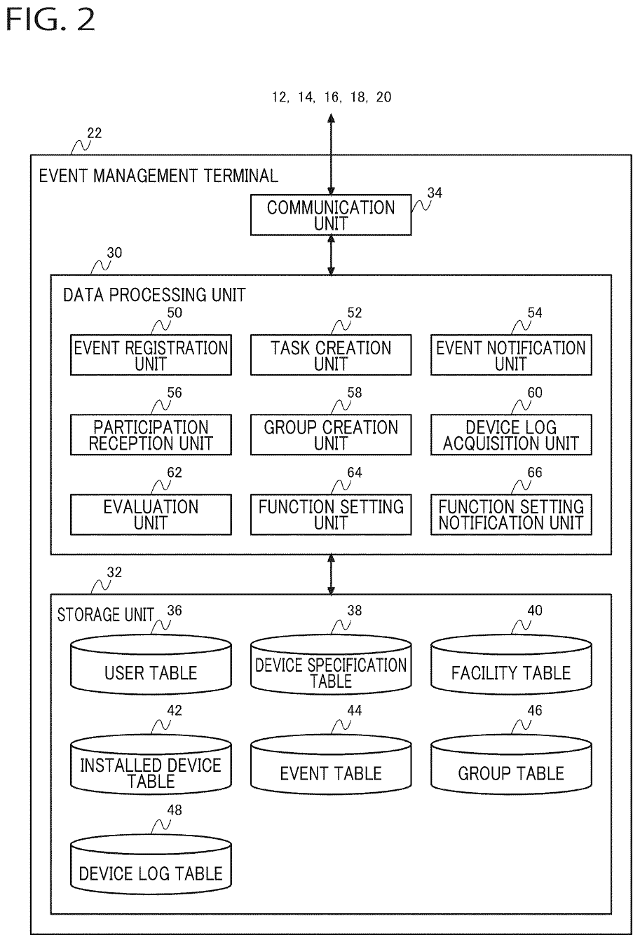

FIG. 2 is a block diagram showing functional blocks of the event management apparatus 22 of FIG. 1. The blocks shown in the block diagrams of the present disclosure are implemented in hardware such as devices and mechanical apparatus exemplified by a CPU and a memory of a computer, and in software such as a computer program. FIG. 1 depicts functional blocks implemented by the cooperation of those. It will be understood by those skilled in the art that these functional blocks are implemented in a variety of manners by a combination of hardware and software.

The event management apparatus 22 includes a data processing unit 30, a storage unit 32, and a communication unit 34. The data processing unit 30 executes various data processes and arithmetic processes. The storage unit 32 stores data referenced or updated by the data processing unit 30. The communication unit 34 communicates with the external apparatus according to a predetermined communication protocol. The data processing unit 30 transmits and receives data to and from the device 12, the user terminal 14, the device manufacturer terminal 16, the facility manager terminal 18, and the event operator terminal 20 via the communication unit 34.

The storage unit 32 includes a user table 36, a device specification table 38, a facility table 40, an installed device table 42, an event table 44, a group table 46, and a device log table 48.

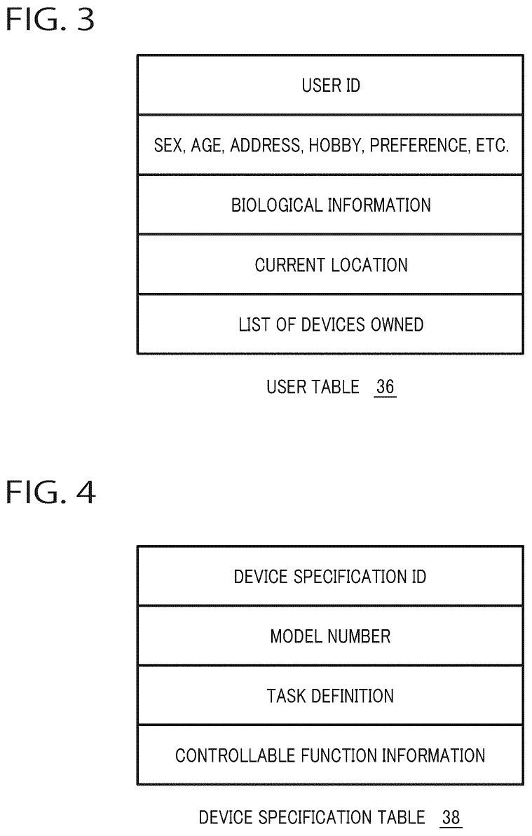

FIG. 3 shows an example of the user table 36. Information stored in the user table 36 (hereinafter also referred to as “user information”) includes various attribute information related to the user such as sex, age, address, hobby, preference, and the like. The user information also includes the user's biometric information, the user's current location, and a list of devices 12 owned by the user. The user's biometric information is inclusive of, for example, the feature amount of the user's face image and the user's fingerprint data.

FIG. 4 shows an example of the device specification table 38. Information stored in the device specification table 38 (hereinafter also referred to as “specification information”) includes a task definition and a controllable function information. The task definition includes a definition of a task in the device 12 that can be used in the event and a rule for approving that the task has been executed (execution approval rule). In the case the device 12 is an IoT toilet seat, for example, the task may be using the washing function provided in the IoT toilet seat. Further, the execution approval rule may be that a “washing flag=1” is recorded in the log of the IoT toilet seat.

The controllable function information indicates a function provided in the device 12, and a function (hereinafter also referred to as a “controllable function”) that can be controlled from the external apparatus via the communication network 24. Further, the controllable function information includes information indicating a method for controlling the function of the device 12 from outside. In the case the device 12 is an IoT toilet seat, for example, the controllable function may be a function to set a guidance voice, and the control method may be an API (Application Programming Interface) call via a communication network. The controllable function information may include, as information indicating the control method, identification information on the device 12 to which the control information is transmitted and data that expresses, in the URL format, and a method and a parameter for setting the function.

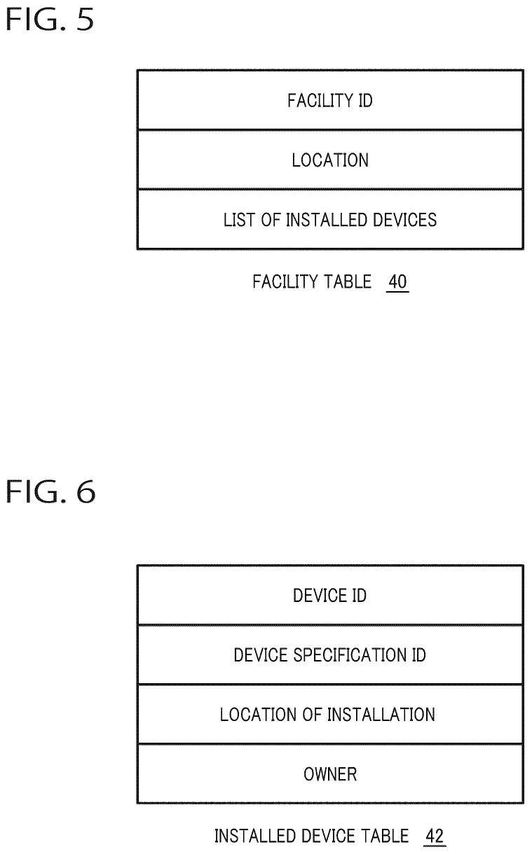

FIG. 5 shows an example of a facility table 40. Information stored in the facility table 40 (hereinafter also referred to as “facility information”) includes the location of the facility and a list of devices 12 installed in the facility.

FIG. 6 shows an example of the installed device table 42. Information stored in the installed device table 42 (hereinafter also referred to as “installed device information”) includes the location of installation (e.g., facility ID) and the owner of the device 12.

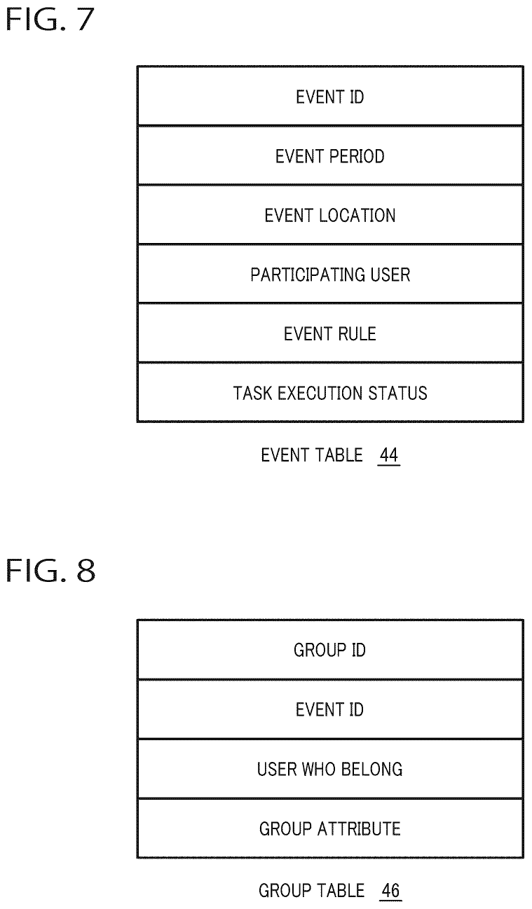

FIG. 7 shows an example of the event table 44. Information stored in the event table 44 (hereinafter also referred to as “event information”) includes participating users, an event rule, and a task execution status. The participating users comprise a list of users participating in the event. The event rule is data that defines a task in the event. Further, the event rule includes a task accomplishment condition that defines the device 12 for which the rule is defined, defines which function should be used, and defines how many times the function should be used to determine that the task has been accomplished. Further, the event rule includes details that sets the function of the device 12 when the task of the device 12 is accomplished.

The task execution status is data indicating a status of execution (in other words, a level of accomplishment) of the task by each user. In the exemplary embodiment, the task execution status includes data indicating a status of execution (in other words, a level of accomplishment) of the task by each group.

FIG. 8 shows an example of the group table 46. Information stored in the group table 46 (hereinafter also referred to as “group information”) includes an event ID, users who belong, and a group attribute. The event ID is an ID of an event for which the group is set and is, in other words, an ID of the event for which the level of task accomplishment is determined according to the group. The users who belong comprise a list of users belonging to the group. The group attribute is an attribute of users belonging to the group and is, specifically, an attribute common to a plurality of users belonging to the group. For example, the group attribute may include information indicating a member, among the members of an idol group, who is commonly supported by the plurality of users belonging to the group.

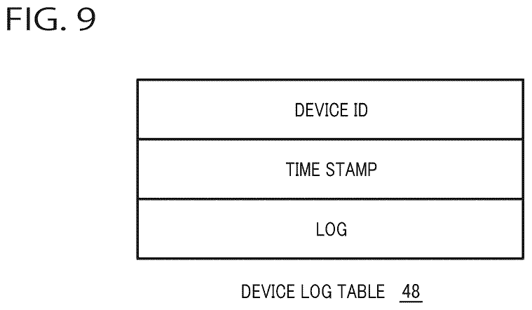

FIG. 9 shows an example of the device log table 48. The data stored in the device log table 48 includes a time stamp and a log. The log represents data for a log output from the device 12 (hereinafter also referred to as “device log”) and represents data indicating a function of the device 12 used by the user. The time stamp represents, for example, data recorded in the device log to indicate the date and time when the user uses the function of the device 12.

Returning back to FIG. 2, the data processing unit 30 includes an event registration unit 50, a task creation unit 52, an event notification unit 54, a participation reception unit 56, a group creation unit 58, a device log acquisition unit 60, an evaluation unit 62, a function setting unit 64, and a function setting notification unit 66. The functions of these plurality of function blocks may be implemented in a computer program, and the computer program may be installed in the storage of the event management apparatus 22. The processor (CPU, etc.) of the event management apparatus 22 may exhibit the functions of the plurality of functional blocks by reading this computer program into the main memory and executing the program.

The operation of the event management system 10 according to the above configuration will be described.

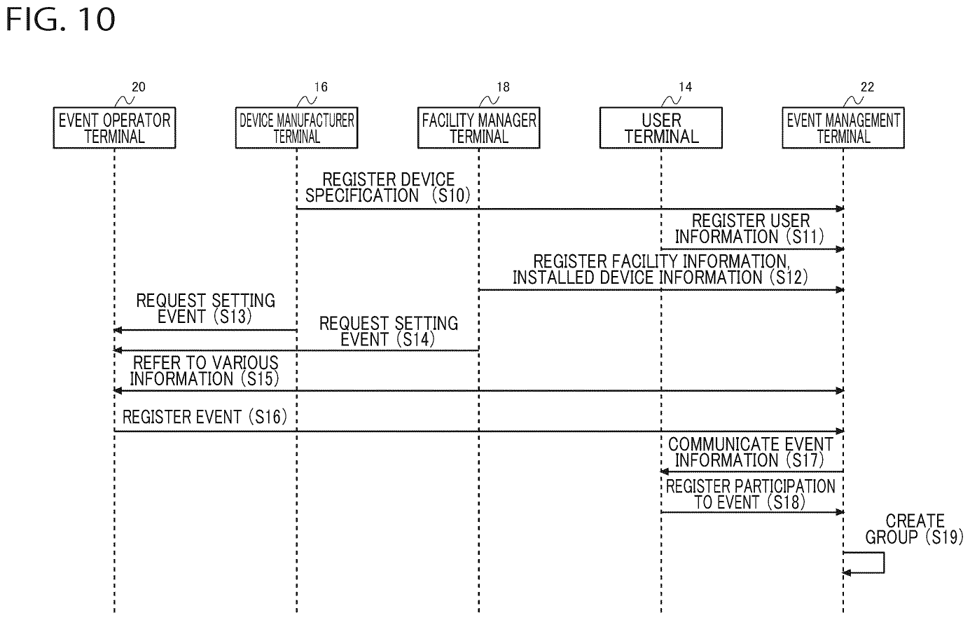

FIG. 10 is a sequence chart showing an operation of the event management system 10 of the exemplary embodiment. The device manufacturer terminal 16 transmits the device specification information shown in FIG. 4 input by a person in charge at the manufacturing company of the device 12 to the event management apparatus 22 (S10). The event management apparatus 22 stores the device specification information transmitted from the device manufacturer terminal 16 in the device specification table 38.

The user terminal 14 transmits the user information shown in FIG. 3 input by the user to the event management apparatus 22 (S11). The event management apparatus 22 stores the user information transmitted from the user terminal 14 in the user table 36. The facility manager terminal 18 transmits the facility information shown in FIG. 5 and the installed device information shown in FIG. 6 input by the facility manager to the event management apparatus 22 (S12). The event management apparatus 22 stores the facility information transmitted from the facility manager terminal 18 in the facility table 40, and stores the installed device information transmitted from the facility manager terminal 18 in the installed device table 42.

The person in charge at the manufacturing company of the device 12 requests the eventer to plan an event for which a task to promote the use of the device 12 of the company's device 12 is set (S13). Alternatively, the facility manager requests the eventer to plan an event which is held near the company's facility and for which a task related to the use of the device 12 installed in the company's facility is set (S14). The requests of S13 and S14 may be realized by communication between the device manufacturer terminal 16, the facility manager terminal 18, and the event operator terminal 20, or may be made without communication between these devices.

The event operator terminal 20 acquires, in accordance with an operation performed by the eventer, the user information, device specification information, facility information, installed device information, and the like registered in the event management apparatus 22 from the event management apparatus 22 and displays the information (S15). The eventer refers to these information items to determine an event rule including a task set in the event and a bonus offered when the task is accomplished.

For example, the eventer may refer to the device specification information on the device 12 installed in a facility around the event venue and determine the task defined in the device specification information as the task set in the event. This task defines a location of installation, model, and function of the device 12 for which the task is set. Further, the eventer determines a task accomplishment condition (the number of times the device 12 is used, etc.) in consideration of the effort or difficulty experienced when the device 12 for which the task is set is used. Further, the eventer determines, based on the controllable function indicated by the device specification information on the device 12, the detail of function setting as a bonus offered when the task is accomplished. The eventer sets the event rule that includes the task, the task accomplishment condition, and the detail of device control determined in this way.

An example of how the event detail is examined by the eventer will be further described. (1) The eventer may refer to the user information (for example, user attribute such as sex and age) stored in the user table 36 of the event management apparatus 22 and extract a desired user as the target user of the event. (2) The eventer may refer to the device specification information (location, function, etc. of the device 12) stored in the device specification table 38 of the event management apparatus 22, and extract the device 12 for which the task linked to the event is set.

(3) The eventer may examine the event rule based on user information, device specification information, facility information, and installed device information. The event rule may include, for example, information indicating the device 12 for which the task is set and its function, the number of times of use, and the bonus offered when the task is accomplished. The information indicating the bonus offered when the task is accomplished may include, for example, information indicating how to adjust the function of the device 12. The eventer may be other than individuals or corporations who make a living by planning events. For example, the eventer may be a person who planed and developed the device 12, and a trial test of the device 12 may be planned or executed through the event.

The event operator terminal 20 transmits the event information (e.g., event period, event location, and event rule) shown in FIG. 7 input by the eventer to the event management apparatus 22 (S16). The event management apparatus 22 stores the event information transmitted from the event operator terminal 20 in the event table 44. The event management apparatus 22 notifies a plurality of users of the event information (including the task information) by transmitting the registered event information (including the task information) to the plurality of user terminals 14 (S17).

The user terminal 14 transmits, to the event management apparatus 22, information indicating that the user participates in the event, i.e., that the user intends to execute the task (S18). The event management apparatus 22 creates a plurality of groups by classifying the plurality of users participating in the event based on the attribute information on each user (S19). The event management apparatus 22 stores the group information shown in FIG. 8 in the group table 46 for each of the plurality of groups.

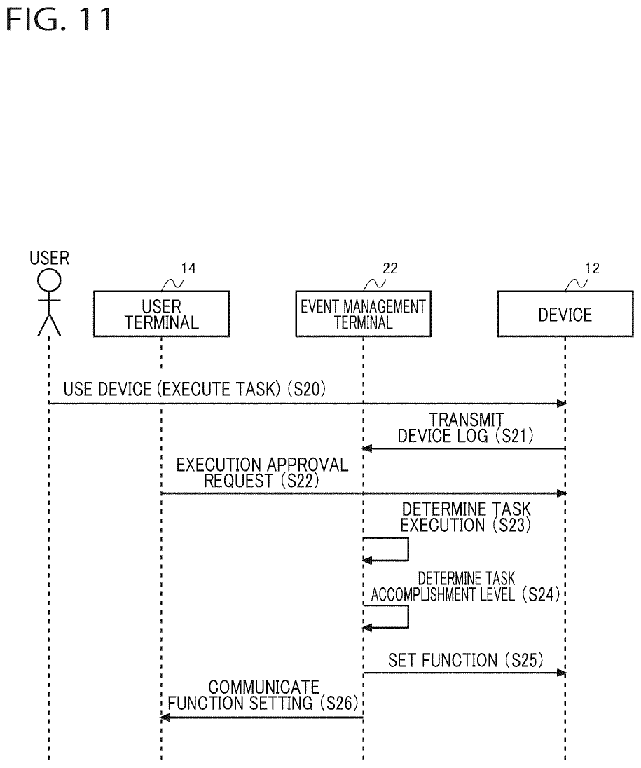

FIG. 11 is a sequence chart showing an operation of the event management system 10 following the operation of FIG. 10. The user uses the device 12 installed in an area around the event venue, i.e., the device 12 for which the task is set (S20). For example, the user goes to see a concert of an idol group as an event, and uses a function of the device 12 for which the task is set (for example, the washing function of an IoT toilet seat, etc.) installed in a shopping center around the concert venue.

Each time the device 12 is used, or periodically, the device 12 transmits, to the event management apparatus 22, a device log including information indicating the function of the device 12 used and a time stamp indicating the date and time of use (S21). The event management apparatus 22 stores, in the device log table 48, the log information shown in FIG. 9 based on the device log transmitted from the device 12.

The user terminal 14 transmits data (also referred to as “execution approval request”) requesting approval that a task has been executed to the event management apparatus 22 in accordance with an operation performed by the user (S22). The event management apparatus 22 determines whether the task is executed by the user based on the device log of the device 12 for which the task is set and the execution approval request from the user (S23). The event management apparatus 22 determines the level of task accomplishment of each of the plurality of groups (S24).

The event management apparatus 22 sets a function suited to a group having a relatively high level of task accomplishment in the device 12 for which the task is set, based on the level of task accomplishment of each of the plurality of groups (S25). The event management apparatus 22 transmits, to the user terminal 14, information related to the function set in the device 12 for which the task is set (S26).

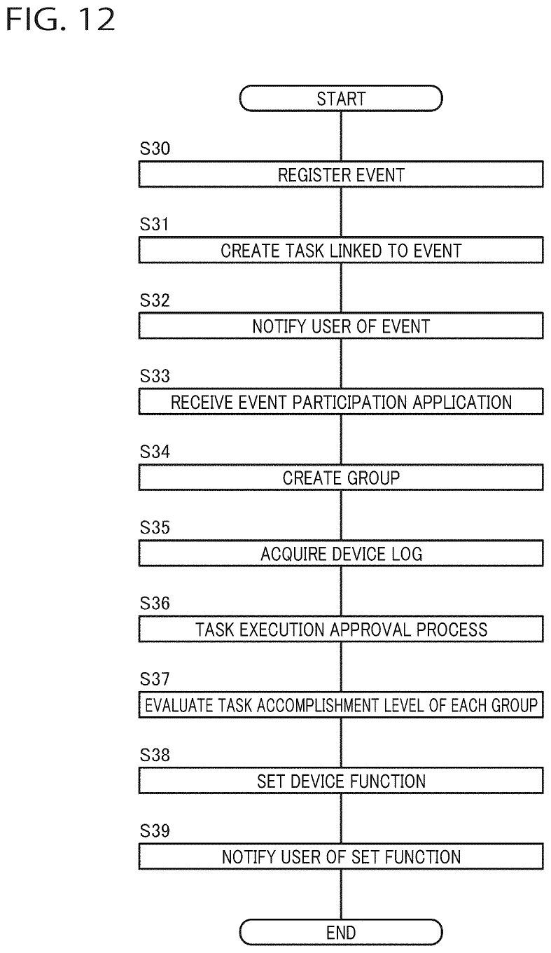

A description will now be given, with reference to the flowchart of FIG. 12, of a detailed process in the event management apparatus 22. As a preliminary preparation, the user information already described with reference to FIG. 3 is registered advance in the user table 36 of the event management apparatus 22. In the device specification table 38 of the event management apparatus 22, the device specification information already described with reference to FIG. 4 is registered in advance. In the facility table 40 of the event management apparatus 22, the facility information already described with reference to FIG. 5 is registered in advance. The installed device table 42 of the event management apparatus 22, the installed device information already described with reference to FIG. 6 is registered in advance.

The event registration unit 50 of the event management apparatus 22 receives the event information (including the event period, event location, event rule, etc.) transmitted from the event operator terminal 20, and stores the event information in the event table 44 (S30). The task creation unit 52 of the event management apparatus 22 creates, based on the event information transmitted from the event operator terminal 20, a task that should be executed by the user in the event and, in the exemplary embodiment, that should be accomplished by the group of the user (S31). In the exemplary embodiment, as already described, the eventer himself or herself determines the task, the task accomplishment condition, and the detail of function setting as a bonus, and sets them in the event information. Therefore, the task creation unit 52 extracts the task, the task accomplishment condition, and the detail of device control from the event information transmitted from the event operator terminal 20, and stores them in the event rule of the event table 44.

In a variation, the task creation unit 52 may autonomously (in other words, automatically) create a task set in the event, based on the event information transmitted from the event operator terminal 20. For example, the task creation unit 52 may refer to the device specification information corresponding to the device 12 installed in an area around the event venue, and determine the task defined in the device specification information as the task set in the event. Further, the task creation unit 52 may determine the detail of function setting as a bonus offered when the task is accomplished, based on the controllable function indicated by the device specification information on the device 12 related to the task. The task creation unit 52 may set data for the autonomously created task in the event table 44 (event rule).

The event notification unit 54 of the event management apparatus 22 transmits the event information stored in the event table 44 to the plurality of user terminals 14 (S32). The event information includes, for example, the event period, event location, and event rule (task detail, bonus, etc.). When the target user of the event is designated in the event information transmitted from the event operator terminal 20, the event notification unit 54 may transmit the event information only to the user terminal 14 of the target user of the event among the plurality of user terminals 14.

The participation reception unit 56 of the event management apparatus 22 receives event participation application information transmitted from the user terminal 14 (S33). The event participation application information includes the ID of the user and the ID of the event in which the user participates. The participation reception unit 56 stores the user ID indicated by the participation application information in the event information (participating users) designated by the event ID indicated by the participation application information.

The group creation unit 58 of the event management apparatus 22 creates a plurality of groups including a plurality of users (also referred to as “participating users”) who have applied for participation in the event. (S34). In the exemplary embodiment, the group creation unit 58 refers to the event table 44 and the user table 36 to identify attributes (for example, sex, age, address, hobby, preference, etc.) of each of the plurality of participating users. The group creation unit 58 classifies the plurality of users so that participating users having the same attribute or similar attributes belong to the same group. When the event is an idol group concert, for example, the group creation unit 58 may create a plurality of groups so that users who support the same member in the idol group belong to the same group. The group creation unit 58 stores the information on each group shown in FIG. 8 in the group table 46.

In the case the function is used by the user and, in other words, in the case the function is exhibited in accordance with the user's operation, the device 12 transmits the device log including data indicating that the user has used the device 12 to the event management apparatus 22. The device log acquisition unit 60 of the event management apparatus 22 can be said to be a usage data acquisition unit, and acquires the device log transmitted from the device 12 (S35). The device log acquisition unit 60 stores data for the acquired device log in the device log table 48.

The evaluation unit 62 of the event management apparatus 22 receives an execution approval request transmitted from the user terminal 14. The execution approval request includes the user ID input by the user who has executed the task, the event ID of the event in which the user participates, and information indicating the date and time of use and the place of use (in other words, the location of installation of the device 12) of the device 12. The evaluation unit 62 executes a process to approve that the task has been executed based on the data for the device log stored in the device log table 48 and the execution approval request transmitted from the user terminal 14 (S36). The process to approve that the task has been executed means a series of processes from checking the event rule against the task execution status to giving an approval when it is determined that the task has been executed. When the evaluation unit 62 approves that the user has executed the task, the evaluation unit 62 stores information indicating that the user has executed the task in the task execution status of the event table 44.

An example of the approval process of S36 will be described. The evaluation unit 62 may identify the device 12 (also referred to as a “user-accessed device”) used by the user, based on the place of usage indicated by the execution approval request and the location of installation of the device 12 indicated by the installed device information). The evaluation unit 62 may approve that the user originating the execution approval request has executed the task provided that the following conditions are met: i) the date and time of use indicated by the execution approval request match the timestamp indicated by the device log of the user-accessed device, ii) the user-accessed device is included in the devices 12 for which the event rule defines that the task is set, and iii) the used function indicated by the device log of the user-accessed device is the function for which the event rule defines that the task is set.

Another example of the evaluation process of S36 will be described. The device log transmitted from the device 12 may include biometric information (for example, face image or fingerprint data) of the device operator. The evaluation unit 62 may acquire the user's biometric information (for example, face image or fingerprint data) from the user table 36 based on the user ID indicated by the execution approval request transmitted from the user terminal 14. The evaluation unit 62 may use a known method to check the biometric information of the user originating the execution approval request against the biometric information indicated by the device log, and determine whether they belong to the same person. The evaluation unit 62 may approve that the user originating the execution approval request has executed the task provided that the following conditions are met: i) the information belongs to the same person, ii) the user-accessed device is included in the devices 12 for which the event rule defines that the task is set, and iii) the used function indicated by the device log of the user-accessed device is the function for which the event rule defines that the task is set.

Still another example of the evaluation process of S36 will be described. The evaluation unit 62 may identify the user as a device operator by comparing the biometric information on the device operator included in the device log with the biometric information of each user stored in the user table 36. The evaluation unit 62 may approve that the user as the device operator has executed the task provided that the user-accessed device is included in the devices 12 for which the event rule defines that the task is set and that the used function indicated by the device log of the user-accessed device is the function for which the event rule defines that the task is set. In this example, the user terminal 14 may not transmit the execution approval request to the event management apparatus 22.

The evaluation unit 62 of the event management apparatus 22 evaluates the level of task accomplishment of the user using the device 12 for which the task is set. In the exemplary embodiment, the evaluation unit 62 derives the level of task accomplishment of each of the plurality of groups, based on the group to which the user using the device 12 for which the task is set belongs (S37). For example, the evaluation unit 62 may add up the number of times the task is executed by a plurality of users belonging to each group, and compare the total value with the task accomplishment condition (in this case, the number of times of task execution) defined by the event rules of the event table 44. The evaluation unit 62 may designate, as a group that has accomplished task, a group for which the total number of times of task execution by the users is equal to or greater than the number of times of task execution as the task accomplishment condition.

The function setting unit 64 of the event management apparatus 22 communicates with the device 12 to set the function of the device 12 according to the level of task accomplishment. In the exemplary embodiment, the function setting unit 64 sets a function determined by a group having a relatively high level of task accomplishment in the device 12 for which the task is set. As already described, each of the plurality of groups includes a plurality of users whose attributes are similar. Thus, the function setting unit 64 sets a function suited to the attribute of users of a group having a relatively high level of task accomplishment in the device 12 for which the task is set (S38).

Specifically, the function setting unit 64 accesses the device 12 for which the task is set via the communication network 24. The function setting unit 64 sets a function suited to the group attribute of the group that has accomplished the task according to the control method indicated by the controllable information, stored in the device specification table 38, on the device 12 for which the task is set. For example, the function setting unit 64 may set the function of the device 12 by calling the API for function setting prepared in advance in the device 12 by using, as an argument, data indicating the function suited to the group that has accomplished the task.

For example, it may be assumed that the event is a concert of an idol group, the device for which the task is set is an IoT toilet seat in a shopping center around the event venue, and the group attribute of the first group is to support the member A of the idol group, and the group attribute of the second group is to support the member B of the idol group. Further, it is assumed that the task accomplishment condition requires that the washing function of the IoT toilet seat is used 10 times, the total number of times that the function is used by the first group is 10 times, and the total number of times that the function is used by the second group is 8 times. In this case, the evaluation unit 62 evaluates that the first group has accomplished the task and the second group has not accomplished the task. The function setting unit 64 sets, in the IoT toilet seat, a function suited to the group attribute of the first group stored in the group table 46. For example, the function setting unit 64 changes the setting of the guidance function of the IoT toilet seat to output the voice of the member A of the idol group as a guidance voice.

Further, when the evaluation unit 62 evaluates that a plurality of groups have accomplished the task, the function setting unit 64 may set a function suited to the attribute of the group with the largest level of task accomplishment in the device 12 for which the task is set. For example, it is assumed that the task accomplishment condition requires that the washing function of the IoT toilet seat is used 10 times, the total number of times the function is used by the first group is 12 times (i.e., the task accomplishment level of 120%), and the total number of times that the function is used by the second group is 10times (i.e., the task accomplishment level of 100%). In this case, the function setting unit 64 may set a function suited to the group attribute of the first group stored in the group table 46 in the IoT toilet seat.

When the function of the device 12 is set by the function setting unit 64, the function setting notification unit 66 of the event management apparatus 22 transmits information indicating that the function of the device 12 has been set to the user terminal 14 (S39). The information indicating that the function of the device 12 has been set may include the detail of the function set in the device 12 and information related to the device 12 for which the task is set. The information communicated by the function setting notification unit 66 may be, for example, a text, image, or sound indicating that “the guidance voice of the IoT toilet seat of the shopping center X has been changed to the voice of the member A of the idol group Y”.

According to the event management apparatus 22 of the exemplary embodiment, the use of the device 12 by the user can be promoted by setting the function of the device 12 according to the level of task accomplishment related to the use of the device 12. In further accordance with the event management apparatus 22, it is possible to support the eventer to plan an event or a new service that uses the device 12 installed in each location. In further accordance with the event management apparatus 22, it is possible to support promotion of use, advertising, and quality testing of the company's device by the manufacturing company of the device 12 and also support trial testing (A/B test or the like) for examination of the function. In further accordance with the event management apparatus 22, it is also possible to facilitate an increase in the number of visitors to the facility near the event venue for execution of the task. In further accordance with the event management apparatus 22, the event can be vitalized by setting a task, which in turn can facilitate vitalization of the region.

Described above is an explanation of the present disclosure based on the exemplary embodiment. The exemplary embodiment is intended to be illustrative only and it will be understood by those skilled in the art that various modifications to combinations of constituting elements and processes of the exemplary embodiment are possible and that such modifications are also within the scope of the present disclosure.

The first variation will be described. The task creation unit 52 of the event management apparatus 22 (or the eventer) may create the first task for the first user (one or a plurality of people) and the second task for second user (one or a plurality of people) different from the first task. Similarly, the task creation unit 52 of the event management apparatus 22 (or the eventer) may create the first task for the first group (one group or a plurality of groups) and the second task for the second group (one group or a plurality of groups) different from the first task. The first task and the second task differ in respect of the device 12 for which the task is set. It is preferable that the device 12 for which the first task is set and the device 12 for which the second task is set are installed at different positions.

In this case, the function setting unit 64 of the event management apparatus 22 may set the function of the device 12 for which the first task is set in accordance with the level of accomplishment of the first task by the first user or the first group. Further, the function setting unit 64 may set the function of the device 12 for which the second task is set in accordance with the level of accomplishment of the second task by the second user or the second group. According to this variation, the first user (or the first group) and the second user (or the second group) can be encouraged to use different devices 12 installed at different positions (e.g., different facilities). This makes it possible to control the flow of people. It makes it easier to suppress concentration of people during particular hours or at a specific place, and to reduce accident risks, infection risks, etc. when, for example, an event such as a concert is held.

A second variation will be described. The task creation unit 52 of the event management apparatus 22 (or the eventer) may set an event rule to dynamically change the task in accordance with the time elapsed since the start of the event, the task execution status, changes in the user's current location, and the like. For example, the task creation unit 52 of the event management apparatus 22 (or the eventer) may create the first task having a relatively high difficulty level and the second task having a relatively low difficulty level, and may create an event rule to switch from the first task to the second task when the number of people executing the task is small relative to the total number of users. The evaluation unit 62 of the event management apparatus 22 may switch, according to the event rule, from the first task to the second task in accordance with the time elapsed since the start of the event, the task execution status, changes in the current location of the user, and the like, and evaluate the task accomplishment level of each user or each group.

A third variation will be described. In the above exemplary embodiment, it has been mainly explained that the event is a concert of an idol group, and the use of the device 12 around the event venue by the user is promoted. The technical idea described in the exemplary embodiment and the variations above is not limited thereto and can be applied to various situations. Hereinafter, the first to fifth use cases that use the technical idea described in the exemplary embodiment and the variations above will be described.

The first use case aims to regulate the flow of baseball fans. In this case, the user information includes information indicating a professional baseball team supported. The group creation unit 58 of the event management apparatus 22 creates a plurality of groups by classifying a plurality of users according to the professional baseball team supported by the user.

The task creation unit 52 of the event management apparatus 22 (or the eventer) creates a task in which users are dispersed according to the professional baseball team supported by the user. The task creation unit 52 creates a task that defines a task related to the use of an IoT device and information on a bonus offered when the task is accomplished. For example, the task creation unit 52 defines that “when the washing function of the toilets A-X installed around the stadium is used within 30 minutes after the game, the stadium lighting in the next game will change to the symbol color of the supported team”.

Information on a bonus offered when the task is accomplished (which can be said to be incentive information) is not mandatory as information included in the task. When a plurality of participants are recruited, it is desired that attribute information that can form a group of participants is included in the user information. This attribute information may include information on a team or information on an idol that the user supports.

According to aspect, the event provider can encourage people to leave the stadium within xx minutes (or leave the stadium at a specified time) after the game. Further, the flow of people can be regulated by setting the task so that routes back to home of a plurality of users are different (in other words, dispersed) by using the position information on the device 12 for which the task is set. It is also possible to encourage users (spectators) who are reluctant to leave the stadium to return home.

Further, the evaluation unit 62 of the event management apparatus 22 counts the number of users (task executioners) who have used a predetermined function of the device 12 for which the task is set, and aggregates the count according to the group. The evaluation unit 62 evaluates a group with a large number of task executioners as having a high level of task accomplishment and determines it as a “dominant group”. After calculating the task accomplishment level of each of the plurality of groups, the evaluation unit 62 may determine the ranking of the groups based on the task accomplishment level of each group.

The function setting unit 64 of the event management apparatus 22 switches, in the next game, the function of the device 12 at the stadium and around the stadium according to the attribute of the dominant group in accordance with bonus information in the event rule. When a group of users who support a professional baseball team A becomes a dominant group, for example, the function setting unit 64 may switch the irradiation color of the illumination equipment at the stadium or around the stadium to the symbol color of the professional baseball team A. According to this aspect, the same advantage as provided by the exemplary embodiment is provided, the user's motivation to execute the task can be enhanced by utilizing the rivalry between groups, and the use of the device 12 can be promoted more efficiently.

The second use case is derived from the first use case and aims to improve the behavioral manners of baseball fans.

The task creation unit 52 of the event management apparatus 22 or the eventer) creates, as the task related to the use of the device 12, a task related to a correct behavior at the stadium or a task related to an environmentally friendly action such as energy saving. The task in this case may be, for example, a task of using the washing function of a toilet in the water-saving mode, or a task of turning off the toilet lighting after using the toilet.

The process in the evaluation unit 62 of the event management apparatus 22 is the same as that of the first use case. The process in the function setting unit 64 of the event management apparatus 22 is also the same as that of the first use case. For example, the function setting unit 64 may switch the lighting color around the toilet according to the task accomplishment level of each group, or may switch the lighting color around the toilet to the symbol color of the supported team indicated by the attribute of the dominant group. According to this aspect, the same advantage as provided by the exemplary embodiment is provided, and an entertainment such as a competition for a position by well- mannered fans can be provided in the stadium.

The third use case aims to allow entry into a different facility when a given facility is entered a predetermined number of times. The task creation unit 52 of the event management apparatus 22 (or the eventer) creates a task related to entry into a certain commercial facility. For example, the task creation unit 52 may designate an alcohol disinfection dispenser installed at each entrance of a commercial facility and having a communication function as a device for which the task is set, and create a task related to the use of the dispenser. The event notification unit 54 of the event management apparatus 22 recruits participants to an event related to the execution of the task. For example, the event notification unit 54 may post a notice for recruitment of event participants on the web page of the commercial facility and receive applications from participants. Further, the event notification unit 54 may send a notice for recruitment of event participants to the user who has downloaded an application related to the commercial facility and receive an application from the participant.

After accepting an event participant, the evaluation unit 62 (or the device log acquisition unit 60) of the event management apparatus 22 acquires information related to the status of task execution by the event participant. The method of acquiring the task execution status does not matter. For example, the evaluation unit 62 may estimate the task execution status based on the position information on the event participant. Alternatively, the evaluation unit 62 may acquire the usage status of the dispenser based on sensing information. Alternatively, the evaluation unit 62 may acquire the usage status of the dispenser based on information related to whether the task has been executed received from the terminal (the user terminal 14) of the event participant.

Still alternatively, identification information such as a two-dimensional code or a barcode may be provided on the device 12 (the dispenser in this example) for which the task is set. The event participant may cause the user terminal 14 to read the identification information, and the user terminal 14 may transmit the identification information to the event management apparatus 22. The evaluation unit 62 may acquire the usage status of the dispenser based on the identification information transmitted from the user terminal 14. Such a method for acquiring the task execution status can also be applied to the event management apparatus 22 of the exemplary embodiment and the variations above. The evaluation unit 62 calculates the number of times the task is executed by the event participant (in this case, the number of times of entry into the commercial facility), and, when the number of times of task execution exceeds a threshold value, evaluates that the event participant has accomplished the task.

The function setting unit 64 of the event management apparatus 22 allows the event participant who has accomplished the task to enter an exclusive VIP facility of the relevant commercial facility. For example, the function setting unit 64 may transmit a control signal for setting the entry/exit control apparatus (such as a door sensor) provided at the entrance of the exclusive VIP facility to allow the event participant who has accomplished the task to enter the room. When the event participants are a group, the function setting unit 64 may transmit a control signal to the entry/exit control apparatus to set the apparatus to allow only users belonging to the dominant group to enter the exclusive VIP facility.

According to this aspect, the same advantage as provided by the exemplary embodiment above plus the following advantages are provided. For example, it can provide the facility side with an added value of entry into the exclusive VIP facility and can provide an effect of attracting customers. In addition, it can effectively enhance the motivation of event participants to go to the facility.

The fourth use case is an application related to driving of an automobile and aims to control automobile congestion (e.g., congestion relief). In this case, the car navigation system of the automobile will be an IoT device linked to the event management apparatus 22. Further, a toilet (an IoT toilet seat, etc.) in a service area on a road will be the device 12 for which the task is set. Further, a vending machine will be the device 12 for which the function is set. That is, the IoT device for which the task is set and the IoT device for which the function is set are different in the fourth use case.

The task creation unit 52 of the event management apparatus 22 (or the eventer) creates a task that includes using toilets in a service area A, a service area B, and a service area C when a predetermined destination is set in the car navigation system. This task includes, for example, a designation of directions and information on a toilet that should be used. In addition, the event rules stipulate a bonus in which a bottle of drink is offered free of charge to the user who accomplished the task in a vending machine near the final destination when the task is accomplished. The event notification unit 54 of the event management apparatus 22 transmits event (task) data including bonus information to the car navigation system of each user, and displays the event (the task) in the car navigation system of each user.

The evaluation unit 62 (the device log acquisition unit 60) of the event management apparatus 22 acquires information indicating that the user has used the device 12 (in this case, the toilet in the service area) for which the task is set. When it can be determined that the user has used the device 12 for which the task is set, based on the acquired information, the evaluation unit 62 evaluates that the task has been accomplished. When the task includes the use of a plurality of devices 12, the task accomplishment level may be evaluated by evaluating the usage status of all the devices 12 for which the task is set, counting the number of devices 12 used, and comparing the count with a threshold value. For example, it will be assumed that five devices 12 that should be used are provided on the route specified in the car navigation system, and the threshold value is 60%. When it is confirmed that the user has used three of the five devices 12 in this case, 3/5=60% so that the evaluation unit 62 may evaluate that the task has been accomplished.

The function setting unit 64 of the event management apparatus 22 may transmit identification information (such as a two-dimensional code) to be presented to the vending machine near the final destination to the terminal of the user evaluated as having accomplished the task. The vending machine near the final destination is equipped with a reader and offers one bottle of drink free of charge when the above identification information is presented to the reader. According to this aspect, it is easier to control the route of the automobile to the destination (for example, the event venue), and it is easier to control the congestion of automobiles heading to the destination.

The fifth use case is an application related to driving of an automobile and aims to improve driving manners. In this use case, a sensing apparatus or a sensing function for detecting the state of driving of the automobile by a user will be the device 12 for which the task is set. Further, the vending machine will be the device 12 for which the function is set. As in the fourth use case, the IoT device for which the task is set and the IoT device for which the function is set are different in the fifth use case, too.

The task creation unit 52 of the event management apparatus 22 sets a task for encouraging the user to observe driving manners when a destination is set in the automobile being driven. The task may be, for example, to drive in the eco mode, in which fuel efficiency is given weight, or not to brake suddenly, or not to start suddenly. The bonus offered when the task is accomplished may be, for example, a lower automobile insurance fee. The event notification unit 54 of the event management apparatus 22 transmits the event (the task) data including bonus information to the car navigation system of each user, and displays the event (the task) in the car navigation system of each user.

The evaluation unit 62 (the device log acquisition unit 60) of the event management apparatus 22 acquires a result of detection of the user's driving state transmitted from the sensing apparatus of the user's automobile. The evaluation unit 62 evaluates the level of task accomplishment of the user based on the result of detection of the user's driving state. When the task of not braking suddenly (or reducing the number of times of sudden braking to xx times or less) is set, for example, the evaluation unit 62 counts the number of times of sudden braking during the driving period. When the number of times of sudden braking of the user's automobile is 0 times or equal to or less than a threshold value, the evaluation unit 62 evaluates that the user has accomplished the task. The task accomplishment level may be reset when the automobile completes the route designated by the car navigation system or based on an elapse of a predetermined time.

The function setting unit 64 of the event management apparatus 22 provides a reward or a bonus to the user based on the task accomplishment level. The process in the function setting unit 64 may be the same as that of the function setting unit 64 of the fourth use case. For example, the function setting unit 64 may transmit, to the terminal of the user evaluated as having accomplished the task, identification information (a two-dimensional code, etc.) with which the user is provided with beverage free of charge by presenting the information to the vending machine near the final destination. According to this aspect, the user's driving manners can be improved. For example, it is considered to be cost-effective for municipalities that aim to be at the top of the ranking of driving manners or want to build a sophisticated image of its own in order to attract residents and companies.

In the embodiment or the variations above, the plurality of functional blocks provided in the event management apparatus 22 may be implemented by being distributed across a plurality of apparatuses. The same process as that of the event management apparatus 22 of the embodiment may be realized by causing these plurality of apparatuses to transmit and receive data to and from each other and coordinating them as a system.

Any combination of the exemplary embodiment and the variation described above will also be useful as an embodiment of the present disclosure. New embodiments created by the combination provide the advantages of exemplary embodiment and the variation combined. It will also be understood by skilled persons that the functions that the constituting elements recited in the claims should achieve are implemented either alone or in combination by the constituting elements shown in the exemplary embodiment and the variations.

The technology described in the exemplary embodiment and the variations may be defined by the following items.

### [Item 1]

An information processing apparatus including:

a task creation unit that creates a task that should be accomplished in relation to a use of a device connected to a network;

a usage data acquisition unit that acquires data related to a user's use of the device;

an evaluation unit that evaluates a level of task accomplishment of the user using the device; and

a setting unit that communicates with the device to set a function of the device according to the level of task accomplishment.

The evaluation unit may evaluate a level of task accomplishment based on the user using the device.

According to this information processing apparatus, the user's motivation to use the device can be increased, and the use of the device by the user can be promoted effectively by setting the function of the device in accordance with the level of task accomplishment related to the use of the device.

### [Item 2]

The information processing apparatus according to Item 1,

wherein the device is a device provided in an area around a venue of an event, and

wherein the user is a participant to the event.

According to this information processing apparatus, the use of the device installed in an area around the event venue can be promoted efficiently in coordination with the event.

### [Item 3]

The information processing apparatus according to Item 1 or 2, further including:

a group creation unit that creates a plurality of groups including a plurality of users,

wherein the evaluation unit evaluates the level of task accomplishment of each of the plurality of groups based on the group that the user using the device belongs to, and wherein the setting unit sets, in the device, a function determined by the group having a relatively high level of task accomplishment.

According to this information processing apparatus, the user's motivation to use the device can be increased effectively, and the use of the device by the user can be promoted effectively by introducing a factor of competition between groups.

### [Item 4]

The information processing apparatus according to Item 3,

wherein each group includes a plurality of users whose attributes are similar,

the setting unit sets, in the device, a function suited to the attribute of the users of the group having a relatively high level of task accomplishment.

According to this information processing system, the value of the bonus provided when the task is accomplished can be further increased for the user, the user's motivation to use the device can be increased effectively, and the use of the device by the user can be promoted effectively.

### [Item 5]

The information processing apparatus according to any one of Items 1 to 4,

wherein, when the function of the device is set by the setting unit, the information processing apparatus notifies the user that the function of the device has been set.

According to this information processing apparatus, the user is prompted to use the device again, and the sense of accomplishment of the task can be provided to the user.

### [Item 6]

A computer-implemented information processing method including:

creating a task that should be accomplished in relation to a use of a device connected to a network;

acquiring data related to a user's use of the device;

evaluating a level of task accomplishment of the user using the device; and

communicating with the device to set a function of the device according to the level of task accomplishment.

According to this information processing method, the user's motivation to use the device can be increased, and the use of the device by the user can be promoted effectively by setting the function of the device in accordance with the level of task accomplishment related to the use of the device.

While various embodiments have been described herein above, it is to be appreciated that various changes in form and detail may be made without departing from the spirit and scope of the invention(s) presently or hereafter claimed.

### CROSS-REFERENCE TO RELATED APPLICATION

This application is based upon and claims the bonus of priority from the prior Japanese Patent Application No. 2022-051915, filed on Mar. 28, 2022, the entire contents of which are incorporated herein by reference.

What is claimed is:

1. An information processing apparatus comprising:
a task creation unit that creates a task that should be accomplished in relation to a use of a device connected to a network;
a usage data acquisition unit that acquires data related to a user's use of the device;
an evaluation unit that evaluates a level of task accomplishment of the user using the device; and
a setting unit that communicates with the device to set a function of the device according to the level of task accomplishment.

2. The information processing apparatus according to claim 1,
wherein the device is a device provided in an area around a venue of an event, and
wherein the user is a participant to the event.

3. The information processing apparatus according to claim 1, further comprising:
a group creation unit that creates a plurality of groups including a plurality of users,
wherein the evaluation unit evaluates the level of task accomplishment of each of the plurality of groups based on the group that the user using the device belongs to, and
wherein the setting unit sets, in the device, a function determined by the group having a relatively high level of task accomplishment.

4. The information processing apparatus according to claim 3,
wherein each group includes a plurality of users whose attributes are similar,
the setting unit sets, in the device, a function suited to the attribute of the users of the group having a relatively high level of task accomplishment.

5. The information processing apparatus according to claim 1,
wherein, when the function of the device is set by the setting unit, the information processing apparatus notifies the user that the function of the device has been set.

6. A computer-implemented information processing method comprising:
creating a task that should be accomplished in relation to a use of a device connected to a network;
acquiring data related to a user's use of the device;
evaluating a level of task accomplishment of the user using the device; and
communicating with the device to set a function of the device according to the level of task accomplishment.
